(19) United States
(12) Patent Application Publication
(10) Pub. No.: US 2006/0255188 A1
(43) Pub. Date: Nov. 16, 2006

(54) Electromagnetic actuator

(76) Inventors: Matthias Bechler, Singen-Friedingen (DE); Jens Bitzer, Uberlingen (DE)

Correspondence Address: BACHMAN & LAPOINTE, P.C., 900 CHAPEL STREET, SUITE 1201, NEW HAVEN, CT, 06510, US

(21) Appl. No.: 11/417,973

(22) Filed: May 3, 2006

(30) Foreign Application Priority Data
May 11, 2005 (DE) 10 2005 022 501.2

(51) Int. Cl. F02M 51/00

(52) U.S. Cl. 239/585.3

(57) ABSTRACT

An electromagnetic actuator comprising an armature (54) which is mounted in a sliding manner in a preferably hollow-cylindrical armature guide tube (50) and can be moved by means of an electric coil device, wherein, in order to form a sliding bearing for the armature, the armature guide tube has on the inside a plurality of protrusions (56) which are arranged around the circumference of the armature guide tube and are formed in one piece from the material of the armature guide tube.

### BACKGROUND OF THE INVENTION

The present invention relates to an electromagnetic actuator.

Such a device is known for example from German patent application 102 35 644 by the Applicant, wherein reference should be made for example to FIG. 1 of this publication to illustrate the background of the invention.

An electromagnetic actuator of the generic type typically comprises a rotationally symmetrical magnet frame which is held in a housing and forms a guide tube for an armature element. The guide tube is surrounded by a coil arrangement.

As a reaction to the coil arrangement being actuated by an electrical signal, a force acts on the armature, as a result of which the latter is moved in the axial direction inside the armature guide tube (references 14, 16, 18 in FIG. 1 of DE 102 35 644).

In creating such devices, which exist in numerous variants and are used for many purposes, the critical factor is the [lacuna] between the outer face of the armature and the (typically hollow-cylindrical) inner face of the guide tube: sufficient play ensures good movement and sliding properties of the armature inside the armature guide tube, but at the same time an air gap which is as small as possible is required for advantageous electromagnetic properties, particularly since the armature must be centered relative to the guide tube so as to minimize transverse forces. This means that traditionally it is necessary to involve considerable manufacturing complexity in order to advantageously adapt the two components to one another in the described manner.

Furthermore, if the armature guide tube is closed at one end, as is also the case in the device shown by way of example in FIG. 1 of DE 102 35 644, any movement of the armature leads to a movement of fluid, so that, in designing the guide tube/armature pair, account also has to be taken of the hydrodynamic properties during the movement; in the cited prior art, this is achieved by means of a hole in the armature. However, this may also be disadvantageous, depending on the specific use purpose.

An alternative known embodiment of a guide tube/armature combination is disclosed in DE 102 18 445. In this case, too, the armature of a magnet arrangement is mounted in a sliding manner in a guide tube, but in this case, in order to form a sliding bearing and to allow a fluid flow between the armature and the armature guide tube, the armature has sliding elements provided on its outer side. While the described hydrodynamic properties can be controlled by such a procedure, and also the centering of the armature in the guide tube is improved, the implementation of such a known device is both complicated in manufacturing terms and may be problematic, for example from the point of view of mass production. This is because, in this case, the armature has to be provided with radially circumferential and partially interrupted protrusions in a complex manner, wherein it is then necessary once again for an associated armature guide tube to be suitably adapted in terms of its clear width to the effective external diameter defined by such protrusions. DE 102 18 445 itself even points to the problem of such a resulting, relatively large air gap (which thus adversely affects the electromagnetic efficiency).

The object of the present invention is therefore to improve an electromagnetic actuator of the generic type with regard to guidance of the armature in the armature guide tube, and in particular to optimize the ease with which such a device can be manufactured and thus the suitability thereof for mass production, and additionally to make the device suitable for use with an armature guide tube which is closed at one end, with fluid flow caused by movement of the armature.

### SUMMARY OF THE INVENTION

This object is achieved by an electromagnetic actuator comprising an armature which is mounted in a sliding manner in a preferably hollow-cylindrical armature guide tube and can be moved by means of an electric coil device, characterized in that, in order to form a sliding bearing for the armature, the armature guide tube has on the inside a plurality of protrusions which are arranged around the circumference of the armature guide tube and are formed in one piece from the material of the armature guide tube. Further developments of the invention are described in the use of the electromagnetic actuator as a hydraulic or pneumatic valve.

For example, it is particularly preferred to configure the armature guide tube such that it is closed at one end; not only does this create a pressure environment which is suitable for example for hydraulic or pneumatic valves, but also the advantages achieved by the present invention can be seen particularly clearly in this case, namely fluid guidance during movement of the piston in the channels delimited by the web-like protrusions according to the invention between the outer face of the armature and the armature guide tube.

It is also particularly preferred to form the plurality of protrusions and provide them around the circumference in the inner face of the armature guide tube in such a way that axial centering of the armature is thus obtained. Not only does this provide optimization in terms of geometry and energy, but also the guidance is optimized for the state in which the coil device is not flowed through.

While on the one hand it is preferred to make the advantageously web-like protrusions extend axially over essentially the entire length of the guide tube, alternative embodiments are conceivable which cover only a partial region of the axial length or which form a broken line, that is to say represent a linear sequence of individual protrusions. However, it is advantageous that, in any case, at least a partial section of the protrusions can cooperate with a partial section of the armature.

The shape and profile of a protrusion to be formed in the guide tube may also be selected at will, depending on the flow conditions and field of use and the permitted air gap width; any suitable protrusion cross sections having a relatively large, or alternatively a minimized, bearing surface are conceivable here and are covered by the present invention.

One significant advantage of the present invention lies in the fact that, based on a non-specifically formed armature guide tube, adaptation to the circumferential geometry of a piston that is to be used can take place by means of suitable fine machining during the formation (e.g. engraving) of the protrusions according to the invention. This advantageously means that inexpensive mass-produced parts can be used as starting material for the armature guide tube, which merely have to be adapted to the armature by means of one further machining step, namely the formation of the protrusions, in the required precise machining operation.

As a result, a solution to the problem of precise and reliable guidance of an armature in an armature guide tube for electromagnetic actuators is combined with controlled air gap conditions and advantageous properties in respect of fluid flows in the armature guide tube in a surprisingly simple and elegant manner by virtue of the present invention.

### BRIEF DESCRIPTION OF THE DRAWINGS

Further advantages, features and details of the invention will emerge from the following description of preferred examples of embodiments and with reference to the drawings, in which:

FIG. 1 shows a schematic longitudinal section through an armature guide tube which is closed at one end according to a first preferred embodiment of the present invention, with a schematically shown armature;

FIG. 2 shows a cross-sectional view of the device according to FIG. 1;

FIG. 3 shows a perspective view of an armature guide tube according to a further example of embodiment of the invention;

FIG. 4 shows a longitudinal section through the armature guide tube of FIG. 3;

FIG. 5 shows a perspective view of half of the armature guide tube shown in FIGS. 3 and 4, obtained through the longitudinal section; and

FIG. 6 shows a further example of embodiment with an open guide tube which is closed at both ends by cores.

### DETAILED DESCRIPTION

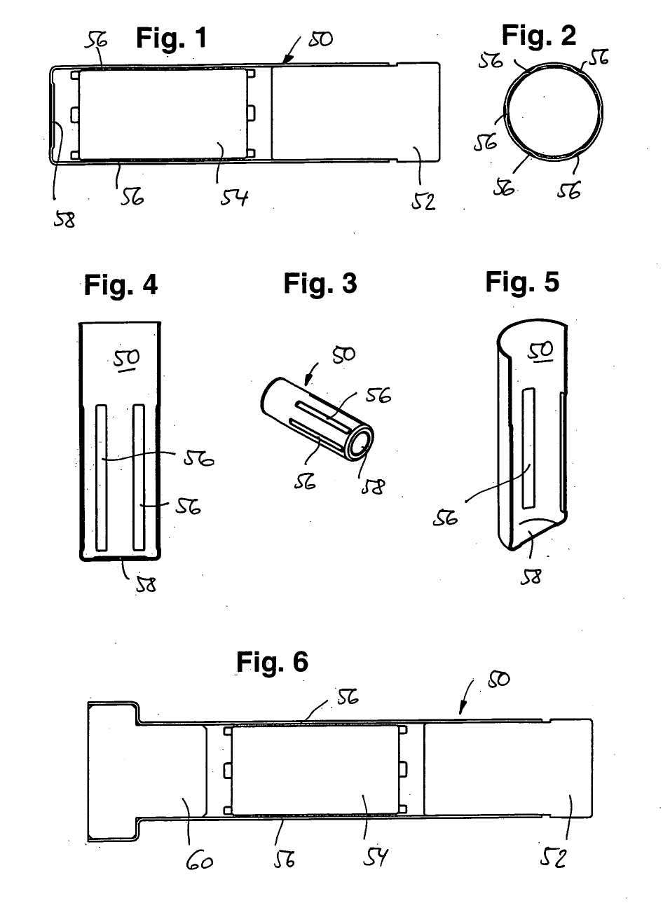

In respect of the structural formation of the peripheral equipment for the present invention, namely the manufacture of an electromagnetic actuator comprising a core held in a housing with an attached armature guide tube and the coil arrangement which surrounds the armature guide tube, reference is made for example to the generic document DE 102 35 644 A1 (for example FIG. 1 therein along with the associated description). However, as shown in FIGS. 1 to 5, the armature guide tube (which is referred to as the “magnet frame” in the prior art) is formed by a tubular or bushing-like element 50 which is made of magnetically nonconductive material and is produced by deep-drawing; FIG. 1 shows how this element is closed at one end by a core region 52, and an armature 54 is also shown in the sectional views of FIGS. 1, 2, said armature being kept centered in a central position by six protrusions 56 which are distributed radially around the circumference of the tube 50. In the illustrated embodiment, the protrusions extend over virtually the entire length of the armature guide tube, which furthermore has a closed bottom 58.

The example of embodiment of FIGS. 3 to 5 shows in further detail the structural design as a sleeve-like bushing. The protrusions 56 which run axially in the longitudinal direction of the armature guide tube are formed by lateral pressing or engraving operations, which protrusions, in the course of fine machining and adaptation to the geometric conditions of a respective armature element to be used, can be adjusted in terms of their dimensions, in particular in terms of their height (which defines the air gap between the armature and the guide tube and also the mobility of the armature).

FIG. 6 shows a variant of the above-described embodiments; the closed bottom (reference 58 in FIGS. 1 to 5) is replaced by a core element 60 which is installed subsequently. A ⅔-way valve can thus be produced for example in a particularly simple manner with appropriate fluid guidance through the cores.

1. An electromagnetic actuator comprising an armature (54) which is mounted in a sliding manner in a preferably hollow-cylindrical armature guide tube (50) and can be moved by means of an electric coil device, wherein, in order to form a sliding bearing for the armature, the armature guide tube has on the inside a plurality of protrusions (56) which are arranged around the circumference of the armature guide tube and are formed in one piece from the material of the armature guide tube.

2. The device as claimed in claim 1, wherein the armature guide tube at one end forms a closed bottom face (58) which is preferably integrally formed in one piece.

3. The device as claimed in claim 1, wherein the protrusions (56) include means for centering the armature concentrically in the armature guide tube.

4. The device as claimed in claim 1, wherein the protrusions (56) extend in an axial direction of the armature guide tube.

5. The device as claimed in claim 4, wherein the protrusions extend over the entire axial length of the armature guide tube.

6. The device as claimed in claim 4, wherein the protrusions extend in the axial direction over a partial section of the armature guide tube in such a way that, in each position of the armature relative to the armature guide tube, a section of an outer face of the armature cooperates with a section of the protrusions.

7. The device as claimed in claim 4, wherein the protrusions represent a broken line along their direction of extension.

8. The device as claimed in claim 1, wherein the protrusions form one of a semicircular, circular segment, triangular, and trapezoidal cross-sectional shape when seen in radial cross section.

9. The device as claimed in claim 1, wherein the armature guide tube is produced by deep-drawing from a metal material and then forming the protrusions in an armature-specific manner from the deep-drawn material.

10. The electromagnetic actuator as claimed in claim 1, wherein the actuator is part of one of a hydraulic and pneumatic valve.
